(19) United States
(12) Patent Application Publication
(10) Pub. No.: US 2026/0359147 A1
(43) Pub. Date: Nov. 12, 2026

(54) SYSTEMS AND METHODS FOR INPUT INJECTION

(71) Applicant: Netflix, Inc., Los Gatos, CA (US)

(72) Inventors: Albert De Nova Santana, San Diego, CA (US); Olivier Poitrey, Le Chesnay (FR); Bernice Beryl Oosterling, Bellevue, WA (US); Holger Schmidt, Cotati, CA (US)

(21) Appl. No.: 19/427,389

(22) Filed: Dec. 19, 2025

Related U.S. Application Data
(60) Provisional application No. 63/803,321, filed on May 9, 2025.

(51) Int. Cl. G06F 9/54; A63F 13/63

(52) U.S. Cl. CPC G06F 9/542; A63F 13/63

(57) ABSTRACT

A computer-implemented method includes (1) initiating, by a computing device, an instance of a game running on a game engine, (2) detecting, by the computing device using a software development kit (SDK), a list of input devices connected to the instance of the game, (3) receiving, by the SDK, an input event from an event handler of an input device in the list of input devices, (4) masking, by the computing device, the input event using an Application Programming Interface (API) for the game engine to generate an altered input event, and (5) injecting, by the API, the altered input event to the instance of the game from the SDK. Various other methods, systems, and computer-readable media are also disclosed.

### CROSS REFERENCE TO RELATED APPLICATION

This application claims the benefit of U.S. Provisional Application No. 63/803,321, filed 9 May 2025, the disclosure of which is incorporated, in its entirety, by this reference.

### BACKGROUND

For gaming services, the ability to detect and manage input devices and peripherals can be important for acting as an intermediary between user devices and a video game. For example, a video game may require input from specific types of controllers, and the gaming service can map controls from a user’s input device to the required controls. However, some games require more unique types of input, such as using the gyroscope of a smartphone to control a game. Additionally, some games require multiple instances of the same type of input, such as a game that requires a different mouse for each player.

Traditional systems and platforms often do not have the capability for managing unique sets of input. For example, some platforms or operating systems merge input events from multiple connected mice into a single source of input. In this example, games that require separate mice for different players may not be playable on such platforms. Additionally, traditional methods for receiving commands from input devices and passing the commands to a game instance may attempt to intercept library calls and inject input to the operating system or platform of a host system. In these examples, traditional systems have a lower-level layer where input is inserted, and games can then fetch the input commands from that layer. However, input types and quantity are then limited by limitations of controllers and controller editors, and input devices may have compatibility issues with a given operating system or game engine. Furthermore, a game engine in a traditional system can synchronize all input with the game loop and, subsequently, implement input from all devices for a particular frame. However, this creates latency issues due to navigating multiple layers of abstraction within the engine prior to the game receiving an input command. Thus, better methods of injecting input events for environments such as gaming systems are needed to reduce latency and increase flexible use of different types and quantities of peripheral devices.

### SUMMARY

As will be described in greater detail below, the present disclosure describes systems and methods for input injection, particularly in gaming environments. In one example, a computer-implemented method for input injection includes initiating, by a computing device, an instance of a game running on a game engine. The method also includes detecting, by the computing device using a software development kit (SDK), a list of input devices connected to the instance of the game. In addition, the method includes receiving, by the SDK, an input event from an event handler of an input device in the list of input devices. Furthermore, the method includes masking, by the computing device, the input event using an Application Programming Interface (API) for the game engine to generate an altered input event. Finally, the method includes injecting, by the API, the altered input event to the instance of the game from the SDK.

In one embodiment, detecting the list of input devices includes exposing event handlers on each input device in the list of input devices and creating an input device instance for at least one device in the list of input devices. Additionally, in this embodiment, receiving the input event includes receiving the input event from the input device instance of the input device and identifying the input device.

In one example, masking the input event includes formatting the input event based on a setting of the game instance, formatting the input event based on a format of an operating system, and/or adding metadata about the input event.

In some embodiments, the computer-implemented method further includes initiating an SDK input mode in response to initiating the instance of the game. In these embodiments, the computer-implemented method further includes receiving, by the API, a request to use a game engine input mode and switching from the SDK input mode to the game engine input mode. In addition, the game engine input mode includes a mode to inject the input event through an interface between the game engine and an operating system. The SDK input mode also includes a mode to inject the input event through the API as the event handler of the input device to bypass the operating system. In the above embodiments, the computer-implemented method further includes receiving, during the SDK input mode, a different input event through a game engine input mode such that the SDK input mode and the game engine input mode are both enabled.

In addition, a corresponding system for input injection includes at least one physical processor and physical memory including computer-executable instructions that, when executed by the physical processor, cause the physical processor to (1) initiate an instance of a game running on a game engine, (2) detect, using a software development kit (SDK), a list of input devices connected to the instance of the game, (3) receive, by the SDK, an input event from an event handler of an input device in the list of input devices, (4) mask the input event using an Application Programming Interface (API) for the game engine to generate an altered input event, and (5) inject, by the API, the altered input event to the instance of the game from the SDK.

In some examples, the above-described method can be encoded as computer-readable instructions on a non-transitory computer-readable medium. For example, a computer-readable medium can include one or more computer-executable instructions that, when executed by at least one processor of a computing device, cause the computing device to (1) initiate an instance of a game running on a game engine, (2) detect, using a software development kit (SDK), a list of input devices connected to the instance of the game, (3) receive, by the SDK, an input event from an event handler of an input device in the list of input devices, (4) mask the input event using an Application Programming Interface (API) for the game engine to generate an altered input event, and (5) inject, by the API, the altered input event to the instance of the game from the SDK.

Features from any of the embodiments described herein may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a flow diagram of an exemplary method for input injection.

FIG. 2 is a block diagram of an exemplary computing system for input injection.

FIG. 3 is a block diagram of an exemplary set of input devices used for an exemplary game instance.

FIG. 4 is a block diagram of an exemplary switch between exemplary modes of input injection.

FIG. 5 is a block diagram of an exemplary SDK input mode that accepts input injection via an exemplary game engine input mode.

FIG. 6 is a block diagram of an exemplary content distribution ecosystem.

FIG. 7 is a block diagram of an exemplary distribution infrastructure within the content distribution ecosystem shown in FIG. 6.

FIG. 8 is a block diagram of an exemplary content player within the content distribution ecosystem shown in FIG. 6.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

This application is directed to the management of input injection for multiple input devices, particularly for users of a gaming service. As will be explained in greater detail below, gaming services often rely on the input devices permitted by an operating system to run games. For example, traditional input injection to a gaming instance often runs through the operating system or a game engine that handles input. However, operating systems often have restrictions on input devices that can hinder full utilization of game capabilities. For example, an operating system might permit multiple keyboards as input but restrict mouse input to a single mouse. For games that could enable multiple users to simultaneously play with multiple mice, these restrictions can prevent sharing the same game instance. Furthermore, traditional game engines synchronize input from multiple devices within a game loop, which can create latency and limit the flexibility of more precise input timing.

In contrast, the approaches described herein bypass traditional input injection to deliver input commands directly to a game instance via a software development kit (SDK). These approaches initiate a game instance, which may be played by one or more users, and detect a list of input devices using the SDK to discover connected devices. For example, a custom Application Programming Interface (API) can manage input for a gaming environment, and individual games can fetch input control information directly from the custom API.

These approaches then detect and receive input events from event handlers of the connected input devices at an SDK level. By masking input events to simulate the same type of input format that the game instance expects from an operating system or game engine, multiple input devices can be used. Additionally, additional information can be included during the masking process to provide information about the devices or the timing of input events. For example, a timestamp of when a user entered a command can be used to provide more detailed information on differences between input from different users’ devices to the game. The approaches then inject input events directly to games using the custom API and at the SDK level to bypass operating system input controls. Furthermore, these approaches can enable switching between an SDK input injection mode and more traditional game engine input injection modes to provide benefits unique to traditional input injection modes, such as ease of porting to new systems, in addition to the more custom input injection of the SDK input mode.

The approaches described herein enable platforms and gaming services to add as many peripheral devices as needed without limitations based on the operating system. For example, the disclosed approaches enable multiple cursors with multiple mouse devices to be used. As another example, the disclosed approaches can enable game developers to utilize the custom API and the SDK to improve capabilities for games with more advanced input requirements than is available on existing platforms, such as input using a combination of devices’ controls. In addition, these approaches improve the fields of gaming services and peripheral device management by providing more customized solutions for device input. For example, by enabling multiple instances of the same type of input device, the disclosed approaches improve input for multiplayer environments where multiple players use the same machine or same instance of a game. Additionally, by directly correlating input devices with in-game controls through the SDK, the disclosed approaches eliminate a need for complex input associations. By bypassing a portion of the input stack and directly using APIs for input, the approaches described herein also decrease latency in sending input commands and reduce the complexity of input injection. In other words, the approaches described herein can control the entire pipeline between input events and a game. Thus, the disclosed approaches improve over traditional methods of input injection that are limited by the requirements of operating systems or controllers.

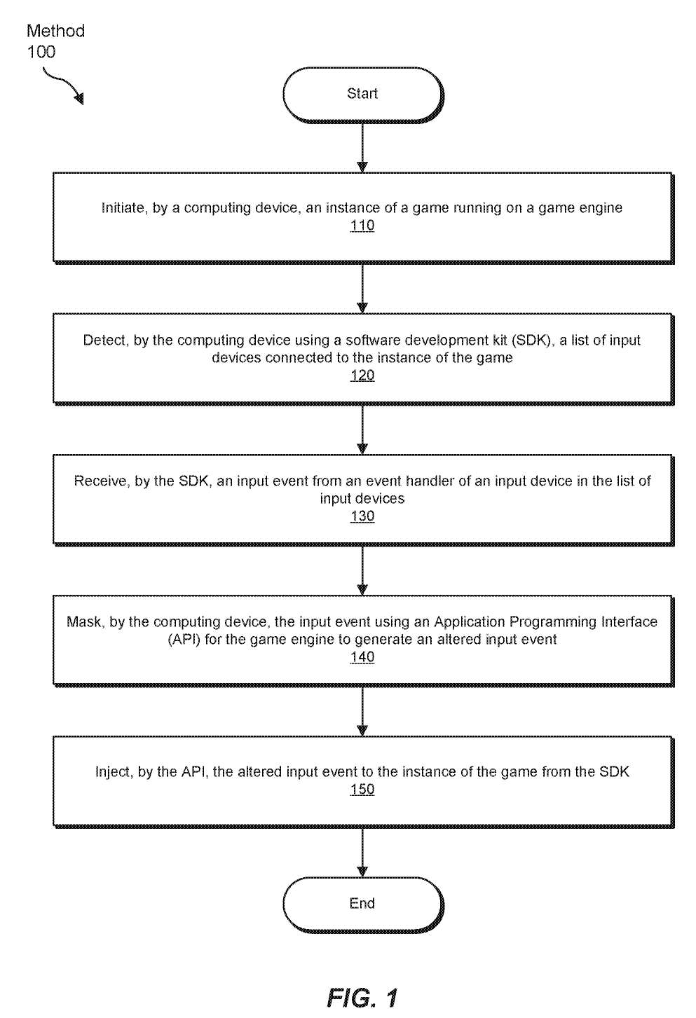

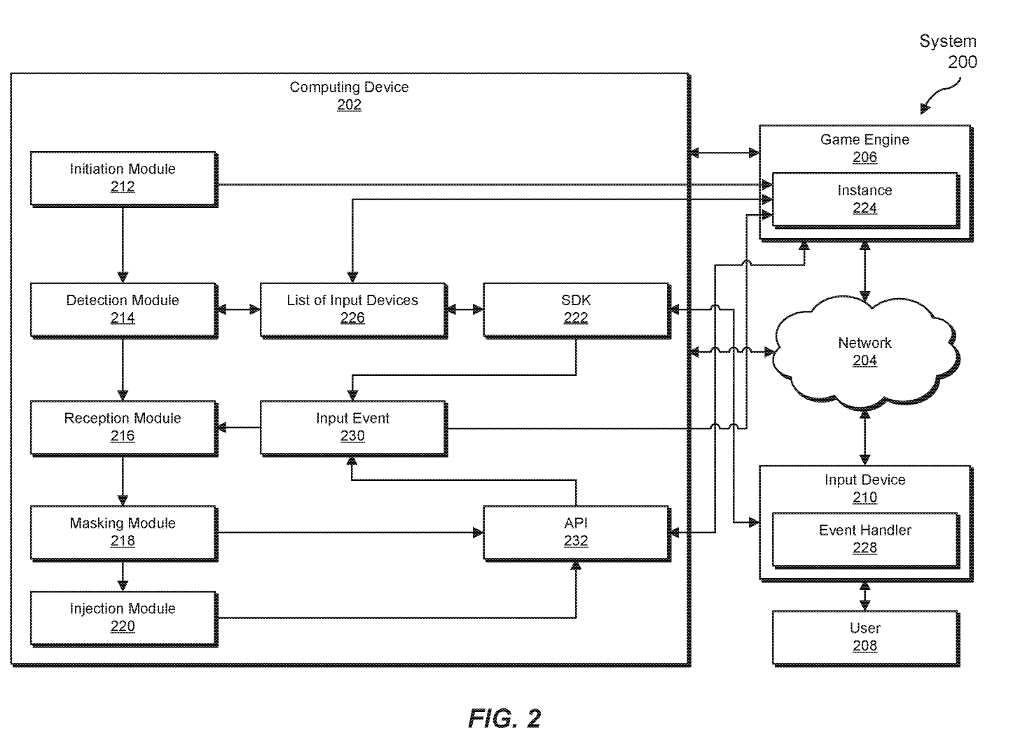

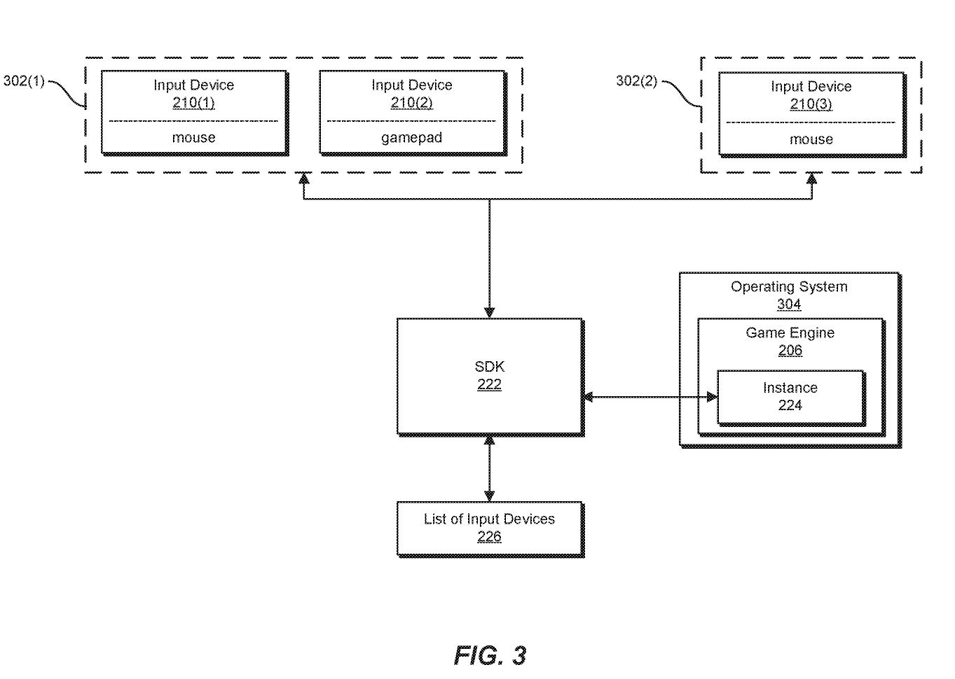

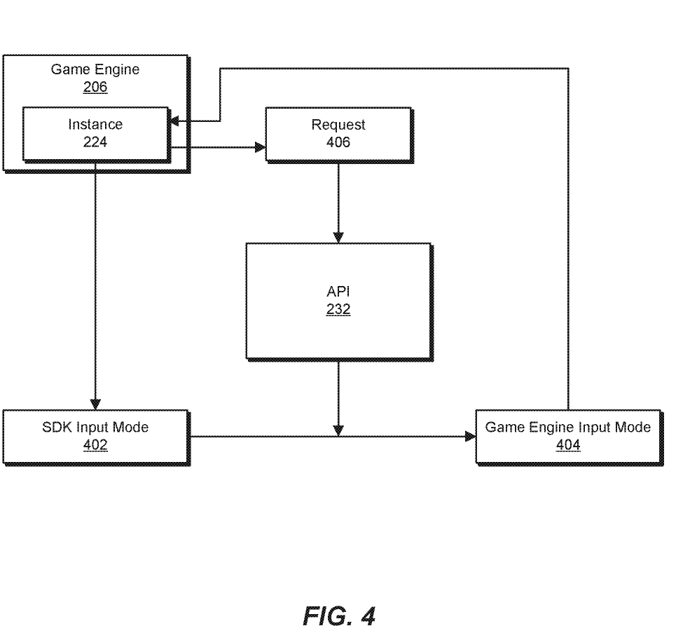

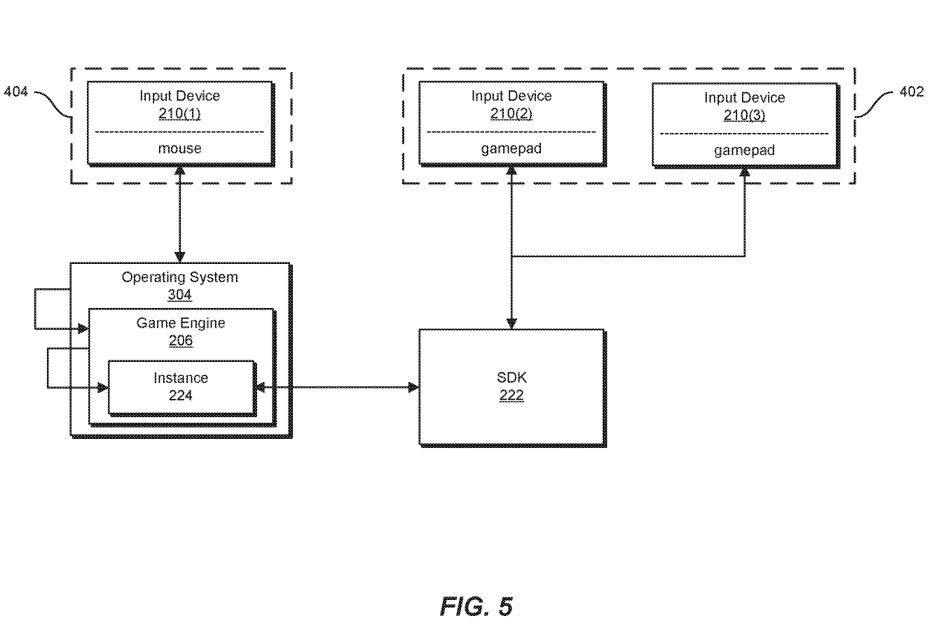

The following description will provide, with reference to FIG. 1, detailed descriptions of computer-implemented methods for input injection. Detailed descriptions of a corresponding exemplary computing system will be provided in connection with FIG. 2. Detailed descriptions of an exemplary set of input devices used for an exemplary game instance will be provided in connection with FIG. 3. In addition, detailed descriptions of an exemplary switch between exemplary modes of input injection will be provided in connection with FIG. 4. Furthermore, detailed descriptions of an exemplary SDK input mode that accepts input injection via an exemplary game engine input mode will be provided in connection with FIG. 5.

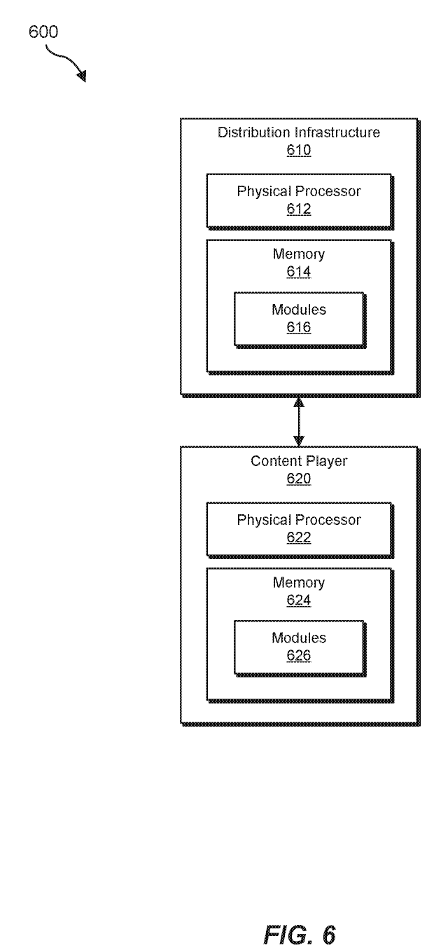

Because many of the embodiments described herein may be used with substantially any type of computing network, including distributed networks designed to provide video content to a worldwide audience, various computer network and video distribution systems will initially be described with reference to FIGS. 6-8. These figures will introduce the various networks and distribution methods used to provision video content to users.

FIG. 1 is a flow diagram of an exemplary computer-implemented method 100 for input injection. The steps shown in FIG. 1 can be performed by any suitable computer-executable code and/or computing system, including the systems illustrated in FIGS. 6-8, computing device 202 in FIG. 2, or a combination of one or more of the same. In one example, each of the steps shown in FIG. 1 represents an algorithm whose structure includes and/or is represented by multiple sub-steps, examples of which will be provided in greater detail below. In some examples, all of the steps and sub-steps represented in FIG. 1 can be performed by one device (e.g., either a server or a client computing device). Alternatively, the steps and/or substeps represented in FIG. 1 can be performed across multiples devices (e.g., some of steps and/or sub- steps can be performed by a server and other steps and/or sub-steps can be performed by a client computing device).

As illustrated in FIG. 1, at step 110, one or more of the systems described herein initiate, by a computing device, an instance of a game running on a game engine. For example, FIG. 2 is a block diagram of an exemplary system 200 for managing input injection. As illustrated in FIG. 2, an initiation module 212 initiates, as part of a computing device 202, an instance 224 of a game running on a game engine 206. As used herein, the term “game engine” generally refers to a framework and set of resources for developing and executing video games.

In some embodiments, computing device 202 generally represents a device capable of processing and managing game instances for users, including managing user input devices. Computing device 202 can alternatively generally represent any type or form of server that is capable of hosting and/or managing content, such video games for a gaming platform. Examples of computing devices include, without limitation, laptops, tablets, desktops, servers, cellular phones, Personal Digital Assistants (PDAs), multimedia players, embedded systems, wearable devices (e.g., smart watches, smart glasses, etc.), gaming consoles, combinations of one or more of the same, or any other suitable computing device. Examples of a server include, without limitation, security servers, application servers, web servers, storage servers, streaming servers, and/or database servers configured to run certain software applications and/or to provide various security, web, storage, gaming, streaming, and/or database services. Additionally, computing device 202 can include distribution infrastructure 610, content player 620, and/or various other components of FIGS. 6-8.

As used herein, the term “input device” generally refers to a client device or a peripheral device capable of sending data as input to another computing device or server. Examples of client and peripheral devices include, without limitation, laptops, tablets, desktops, servers, cellular phones, Personal Digital Assistants (PDAs), multimedia players, embedded systems, wearable devices (e.g., smart watches, smart glasses, etc.), gaming consoles, computer mice, keyboards, game controllers, combinations of one or more of the same, or any other suitable computing device.

Although illustrated as part of computing device 202 in FIG. 2, some or all of the modules described herein can alternatively be executed by a separate server or any other suitable computing device. For example, computing device 202 can represent a separate device for managing requests for a gaming service or, alternatively, represent part of system 200 for providing gaming services as a whole. As another example, computing device 202 can represent an endpoint device or multiple endpoint devices that service client devices for running video games. For example, system 200 can include multiple servers and/or computing devices that include computing device 202, a server hosting instance 224 of a game, databases hosting a variety of data and backend services, and/or any other suitable device or combination of devices.

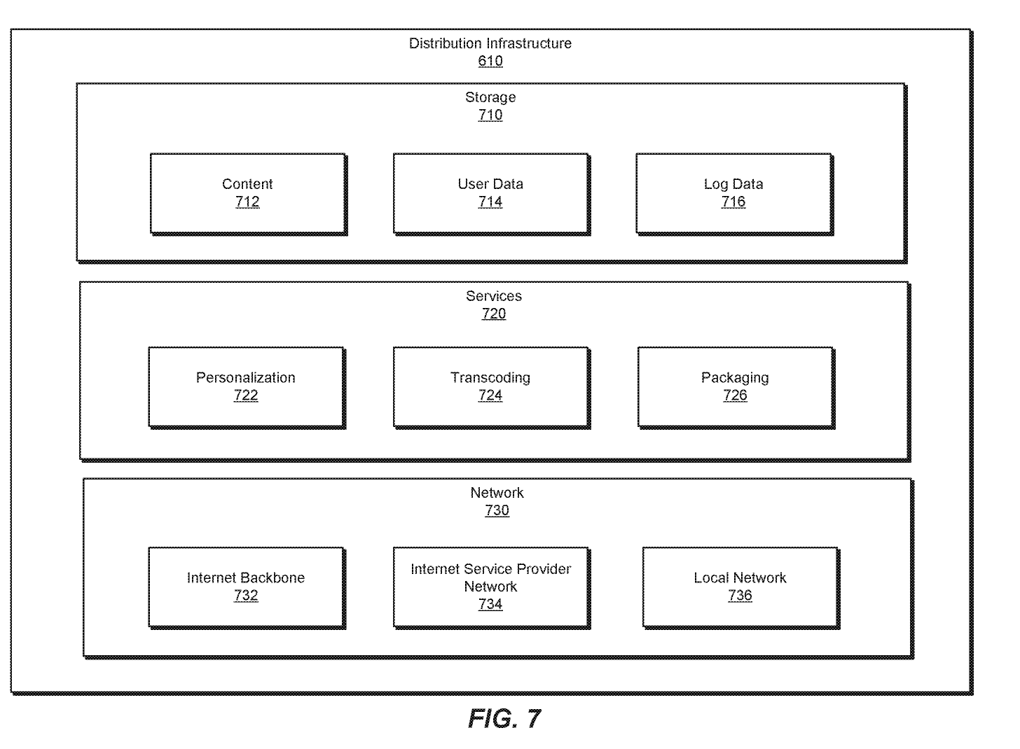

In the above embodiments, computing device 202 is directly in communication with other computing devices and/or in communication with other servers, such as a server hosting game engine 206 and/or instance 224 and input devices such as input device 210, via a network, such as a network 204 of FIG. 2. In some examples, the term “network” refers to any medium or architecture capable of facilitating communication or data transfer. Examples of networks include, without limitation, an intranet, a Wide Area Network (WAN), a Local Area Network (LAN), a Personal Area Network (PAN), the Internet, Power Line Communications (PLC), a cellular network (e.g., a Global System for Mobile Communications (GSM) network), network 730 of FIG. 7, or any other suitable network. For example, network 204 can facilitate data transfer between computing device 202 and instance 224 using wireless or wired connections and between computing device 202 and the server hosting instance 224. In other examples, instance 224 can be hosted on computing device 202 or another device of system 200 and using game engine 206 to run a game. Additionally, network 204 can facilitate data transfer between multiple input devices and instance 224 to control the game.

The systems described herein can perform step 110 in a variety of ways. In some embodiments, instance 224 represents a single copy of a game running in a gaming environment and initiated by a user 208. As used herein, the term “instance” generally refers to a single occurrence of an object. For example, a game instance is a single execution of a game session. In this example, user 208 uses system 200 as a gaming service to run various video games. In additional examples, multiple users run instance 224 together, such as by connecting to system 200 from multiple client devices and/or input devices.

Returning to FIG. 1, at step 120, one or more of the systems described herein detect, by the computing device using a software development kit (SDK), a list of input devices connected to the instance of the game. For example, a detection module 214 detects, as part of computing device 202 in FIG. 2 using an SDK 222, a list of input devices 226 connected to instance 224.

The systems described herein can perform step 120 in a variety of ways. In some examples, detection module 214 detects list of input devices 226 by exposing event handlers on each input device in list of input devices 226. As used herein, the term “expose” generally refers to a method of identifying and making available a resource or process for use by another resource or process. As used herein, the term “event handler” generally refers to a callback routine that is executed when an event occurs. For example, event handlers for input devices can determine what to do based on detecting an input event, such as a mouse click or button push. In these examples, detection module 214 then creates an input device instance, through SDK 222, for one or more devices in the list of input devices. In these examples, input device instances can represent a single session of connection between an input device and a game instance.

As illustrated in FIG. 3, input devices 210(1)-210(2) represent different types of devices that are associated with a single input device instance 302(1). In this example, an input device 210(3) is associated with an input device instance 302(2). For example, input devices instances 302(1)-(2) represent different users playing together for instance 224 of a game. In other examples, each input device instance can include other combinations of input device controls that correspond to a single source of input.

Returning to FIG. 1, at step 130, one or more of the systems described herein receive, by the SDK, an input event from an event handler of an input device in the list of input devices. For example, a reception module 216 receives, by SDK 222 as part of computing device 202 in FIG. 2, an input event 230 from an event handler 228 of an input device 210 in list of input devices 226.

The systems described herein can perform step 130 in a variety of ways. In one embodiment, reception module 216 receives input event 230 from the input device instance of input device 210 and, subsequently, identifies input device 210 using SDK 222. In the example of FIG. 3, SDK 222 can recognize each of input devices 210(1)-(3) and identify the types of devices. In other words, SDK 222 receives input events from event handlers of each input device or each input device instance and sends the input events to an API. Based on receiving input from SDK 222 and each input device, the association between input devices and in-game controllers is predefined such that instance 224 of the game can determine which subsequent input events are from which input devices.

Returning to FIG. 1, at step 140, one or more of the systems described herein mask, by the computing device, the input event using an Application Programming Interface (API) for the game engine to generate an altered input event. For example, a masking module 218 masks, as part of computing device 202 in FIG. 2, input event 230 using an API 232 for game engine 206.

The systems described herein can perform step 140 in a variety of ways. As used herein, the term “application programming interface” generally refers to a software interface that facilitates interactions between computing devices, such as between computing device 202, a server hosting game engine 206, and input device 210. As used herein, the term “masking” generally refers to a process to modify data by hiding the original data and generating altered replacement data. For example, masking input events can refer to hiding an original type of input device and emulating input of a different type of input device. In other words, masking can enable the dynamic creation of different input devices and/or alternate inputs from the same input devices. In some examples, masking module 218 masks input event 230 by formatting input event 230 based on a setting of the game instance and/or by formatting input event 230 based on a format of an operating system, such as an operating system 304 in FIG. 3, an operating system of computing device 202, and/or an operating system of a client device of user 208 that connects to game engine 206. As used herein, the term “setting” generally refers to a parameter controlling a function or behavior of software applications. In these examples, a setting of a game can dictate acceptable types of input devices and/or can map specific inputs to specific game functions. As used herein, the term “operating system” generally refers to software that manages hardware and applications for a computing device. In these examples, operating systems can determine what inputs are acceptable for the associated computing devices or servers. By receiving the data directly from an input device and altering the data with the API, masking module 218 can mask the original input as a different type or format of input. For example, masking module 218 can mask input devices 210(1) and 210(2) of FIG. 3 to change mouse input to a standard controller input, or to align with gamepad input similar to input device 210(2), in order to avoid a restriction of a single input mouse set by the operating system. In this example, the game setting can require multiple similar input devices with mouse capabilities that can be altered as game controllers. Alternatively, masking module 218 can bypass the operating system and accept multiple mouse inputs using the API to avoid operating system restrictions and enable a greater variety of input devices for the game instance, as required by the game setting. In other examples, masking module 218 can mask various input devices as custom controllers or with any combination of inputs that can be used by a game, enabling more flexibility for game settings without adhering to operating system limitations.

In some examples, masking module 218 uses API 232 to add metadata about input event 230. For example, input device 210 can detect a timestamp of when user 208 of FIG. 2 enters a command on input device 210, resulting in input event 230. By including the timestamp with input event 230, computing device 202 can provide further context about input event 230 to instance 224. For example, instance 224 can use timestamps of input events from multiple users to determine which input is first when timing is crucial for a game. As another example, instance 224 can use timestamps to improve calculations for a physics simulation used by the game. In other examples, additional information can be added as metadata to provide further detailed information about individual input devices and/or individual input events.

Returning to FIG. 1, at step 150, one or more of the systems described herein inject, by the API, the altered input event to the instance of the game from the SDK. For example, an injection module 220 injects, by API 232 as part of computing device 202 in FIG. 2, input event 230 after alteration to instance 224 from SDK 222.

The systems described herein can perform step 150 in a variety of ways. In one embodiment, injection module 220 uses event handlers exposed on each input device instance to inject input events at an SDK level rather than at a game engine level. In this embodiment, injection module 220 can inject input events via individual input device instances of each input device, bypassing operating system 304 in FIG. 3. In other words, instance 224 of FIG. 2 receives input event 230 as a handler from the instance of input device 210 connected to instance 224 of the game, with the injection facilitated by API 232 to directly send input event 230 to instance 224. In this embodiment, instance 224 can call functions from game engine 206 outside of a game loop such that instance 224 fetches input event 230 as soon as it happens rather than waiting for the next frame of the game, thereby injecting the input sooner in the game logic or simulation. As used herein, the term “game loop” generally refers to a window of time in which input is received and processed and a game state is updated and rendered.

In further embodiments, initiation module 212 further initiates an SDK input mode in response to initiating instance 224. For example, the above-described systems and methods can begin with a game engine input mode as a default and initiate the SDK input mode with the initiation of instance 224. In other examples, the SDK input mode can be made the default, with all game instances beginning with input through SDK 222. In these embodiments, the game engine input mode includes a mode to inject input event 230 through an interface between game engine 206 and an operating system. Specifically, the above-described systems and methods can begin with the game engine input mode as a default and initiate the SDK input mode with the initiation of instance 224. In other embodiments, the SDK input mode can be made the default, with all game instances beginning with input through SDK 222. In these embodiments, the SDK input mode includes a mode to inject input event 230 through API 232 as event handler 228 of input device 210 to bypass the operating system. In these embodiments, API 232 handles input controls and enables the SDK input mode to directly communicate with instance 224, intercepting and redirecting input events from operating systems to game instances. For example, as shown in FIG. 3, during the SDK input mode, SDK 222 can bypass operating system 304 to communicate directly with instance 224. In this example, API 232 of FIG. 2 then directly injects input event 230 to instance 224 without interfacing with operating system 304. In this example, instance 224 directly receives event handlers generated by input devices 210(1)-(3) at the SDK level, rather than through operating system 304. As shown in FIG. 4, upon initiating instance 224, an SDK input mode 402 is also initiated to enable the game to change the input injection method at runtime. In this example, games can switch to SDK input mode whenever needed based on game requirements and settings.

In the above embodiments, initiation module 212 can further receive, by API 232, a request to use a game engine input mode and switch from the SDK input mode to the game engine input mode. In the example of FIG. 4, instance 224 determines a game engine input mode 404 is preferred for a particular game and sends a request 406 to API 232. For example, a keyboard and a mouse can be reported by a primary client device, and computing device 202 or game engine 206 determines these types of input devices are more easily injected via game engine input mode 404, such as for a game engine that does not have an event handler to capture SDK injection. In this example, instance 224 can temporarily switch back to game engine input mode 404 through navigation of a game menu or a user interface (UI). In this example, game engine input mode 404 can represent an engine injection mode that injects input through low-level interfaces between game engine 206 and operating system 304. In alternate examples, the disclosed systems and methods can implement programming code or software plugins for different UI systems that can be used to make input devices available to avoid reverting to game engine input mode 404.

In some examples, reception module 216 further receives, during the SDK input mode, a different input event through a game engine input mode such that the SDK input mode and the game engine input mode are both enabled. Furthermore, in some embodiments, the input mode can depend on a type of input device and/or on primary or secondary input devices for a user or client. For example, simulated gamepads run on smartphones can be exposed by all input devices, and input events from these gamepads continue to be injected in SDK input mode 402. On the other hand, SDK 222 may not be able to expose any APIs for the keyboard and the mouse that are directly attached, and these input device instances are only available when the input devices are connected. In other examples, the disclosed systems and methods can use game engine input mode 404 for a primary input device or primary user and SDK input mode 402 for secondary input devices or secondary users. Thus, a combination of both input modes enables a variety of devices to be used.

As shown in FIG. 5, input devices 210(2)-(3) represent gamepads, which can be emulated by smartphones remotely connecting to instance 224. In this example, input device 210(1) is a mouse physically connected to instance 224. In this example, input devices 210(2)-(3) use SDK input mode 402 to inject input events to instance 224. In contrast, input device 210(1) uses game engine input mode 404 to send input events to operating system 304, which can send the input events to game engine 206 and, subsequently, instance 224. In this example, input devices 210(2)-(3) represent secondary input devices, while input device 210(1) is a primary device of a primary user running instance 224. In this example, SDK input mode 402 enables multiple additional secondary users with various input device types to join the game.

In some examples, for local testing of games on game engine 206, input events cannot be intercepted from directly attached input devices. Alternatively, during local testing, computing device 202 can send input events via a loopback Transmission Control Protocol (TCP) connection established with a game to transmit the input events and avoid a local operating system. Furthermore, the disclosed systems and methods can be used for both local testing and remote deployment. Although described above in the context of gaming environments, the disclosed systems and methods can be used to manage input controls for any type of system or software environment and/or for any type of input devices. For example, the disclosed systems and methods can manage controls for navigating livestreaming or video content.

As explained above in connection with method 100 in FIG. 1, by bypassing potentially complicated operating system or engine limitations, the disclosed systems and methods can help reduce pipeline latency between a user entering a command and a destination receiving it while also improving other performance metrics for software performance, particularly for gaming environments. In contrast to traditional systems that inject inputs from controllers to an operating system, which then manages how the input is sent to a gaming instance, the disclosed systems and methods route the input to the game instance through an API that masks the input as a similar source to the operating system. By sending input events to a game instance the same way an operating system would, the game instance can simply switch input streams and operate the same way. In these examples, the disclosed systems and methods can also mask any variety or combination of input devices and input controls to conform to requirements and settings of the game instance.

Additionally, by using an SDK to detect connected devices and obtain input events through event handlers, the systems and methods described herein can provide associations between input and controllers directly to the gaming instance. Furthermore, by directly sending input from devices at the SDK level, the disclosed systems and methods can provide direct correlation between input and input devices, which may otherwise be difficult to determine for emulated controls such as a smartphone used as a gamepad. The disclosed systems and methods can also provide additional information about input events to the game instance so that the game logic can take into account details such as original timestamps of inputs and adjust accordingly. Thus, the systems and methods described herein improve over traditional methods of managing input from a multitude and variety of input devices.

Content that is created or modified using the methods described herein can be used and/or distributed in a variety of ways and/or by a variety of systems. Such systems can include content distribution ecosystems, as shown in FIGS. 6-8.

FIG. 6 is a block diagram of a content distribution ecosystem 600 that includes a distribution infrastructure 610 in communication with a content player 620. In some embodiments, distribution infrastructure 610 may be configured to encode data and to transfer the encoded data to content player 620 via data packets. Content player 620 may be configured to receive the encoded data via distribution infrastructure 610 and to decode the data for playback to a user. The data provided by distribution infrastructure 610 may include audio, video, text, images, animations, interactive content, haptic data, virtual or augmented reality data, location data, gaming data, or any other type of data that may be provided via streaming.

Distribution infrastructure 610 generally represents any services, hardware, software, or other infrastructure components configured to deliver content to end users. For example, distribution infrastructure 610 may include content aggregation systems, media transcoding and packaging services, network components (e.g., network adapters), and/or a variety of other types of hardware and software. Distribution infrastructure 610 may be implemented as a highly complex distribution system, a single media server or device, or anything in between. In some examples, regardless of size or complexity, distribution infrastructure 610 may include at least one physical processor 612 and at least one memory device 614. One or more modules 616 may be stored or loaded into memory 614 to enable adaptive streaming, as discussed herein.

Content player 620 generally represents any type or form of device or system capable of playing audio and/or video content that has been provided over distribution infrastructure 610. Examples of content player 620 include, without limitation, mobile phones, tablets, laptop computers, desktop computers, televisions, set-top boxes, digital media players, virtual reality headsets, augmented reality glasses, and/or any other type or form of device capable of rendering digital content. As with distribution infrastructure 610, content player 620 may include a physical processor 622, memory 624, and one or more modules 626. Some or all of the adaptive streaming processes described herein may be performed or enabled by modules 626, and in some examples, modules 616 of distribution infrastructure 610 may coordinate with modules 626 of content player 620 to provide adaptive streaming of multimedia content.

In certain embodiments, one or more of modules 616 and/or 626 in FIG. 6 may represent one or more software applications or programs that, when executed by a computing device, may cause the computing device to perform one or more tasks. For example, and as will be described in greater detail below, one or more of modules 616 and 626 may represent modules stored and configured to run on one or more general-purpose computing devices. One or more of modules 616 and 626 in FIG. 6 may also represent all or portions of one or more special-purpose computers configured to perform one or more tasks.

Physical processors 612 and 622 generally represent any type or form of hardware-implemented processing unit capable of interpreting and/or executing computer-readable instructions. In one example, physical processors 612 and 622 may access and/or modify one or more of modules 616 and 626, respectively. Additionally or alternatively, physical processors 612 and 622 may execute one or more of modules 616 and 626 to facilitate adaptive streaming of multimedia content. Examples of physical processors 612 and 622 include, without limitation, microprocessors, microcontrollers, central processing units (CPUs), field-programmable gate arrays (FPGAs) that implement softcore processors, application-specific integrated circuits (ASICs), portions of one or more of the same, variations or combinations of one or more of the same, and/or any other suitable physical processor.

Memory 614 and 624 generally represent any type or form of volatile or non-volatile storage device or medium capable of storing data and/or computer-readable instructions. In one example, memory 614 and/or 624 may store, load, and/or maintain one or more of modules 616 and 626. Examples of memory 614 and/or 624 include, without limitation, random access memory (RAM), read only memory (ROM), flash memory, hard disk drives (HDDs), solid-state drives (SSDs), optical disk drives, caches, variations or combinations of one or more of the same, and/or any other suitable memory device or system.

FIG. 7 is a block diagram of exemplary components of content distribution infrastructure 610 according to certain embodiments. Distribution infrastructure 610 may include storage 710, services 720, and a network 730. Storage 710 generally represents any device, set of devices, and/or systems capable of storing content for delivery to end users. Storage 710 may include a central repository with devices capable of storing terabytes or petabytes of data and/or may include distributed storage systems (e.g., appliances that mirror or cache content at Internet interconnect locations to provide faster access to the mirrored content within certain regions). Storage 710 may also be configured in any other suitable manner.

As shown, storage 710 may store, among other items, content 712, user data 714, and/or log data 716. Content 712 may include television shows, movies, video games, user-generated content, and/or any other suitable type or form of content. User data 714 may include personally identifiable information (PII), payment information, preference settings, language and accessibility settings, and/or any other information associated with a particular user or content player. Log data 716 may include viewing history information, network throughput information, and/or any other metrics associated with a user’s connection to or interactions with distribution infrastructure 610.

Services 720 may include personalization services 722, transcoding services 724, and/or packaging services 726. Personalization services 722 may personalize recommendations, content streams, and/or other aspects of a user’s experience with distribution infrastructure 610. Encoding services, such as transcoding services 724, may compress media at different bitrates which may enable real-time switching between different encodings. Packaging services 726 may package encoded video before deploying it to a delivery network, such as network 730, for streaming.

Network 730 generally represents any medium or architecture capable of facilitating communication or data transfer. Network 730 may facilitate communication or data transfer via transport protocols using wireless and/or wired connections. Examples of network 730 include, without limitation, an intranet, a wide area network (WAN), a local area network (LAN), a personal area network (PAN), the Internet, power line communications (PLC), a cellular network (e.g., a global system for mobile communications (GSM) network), portions of one or more of the same, variations or combinations of one or more of the same, and/or any other suitable network. For example, as shown in FIG. 7, network 730 may include an Internet backbone 732, an internet service provider 734, and/or a local network 736.

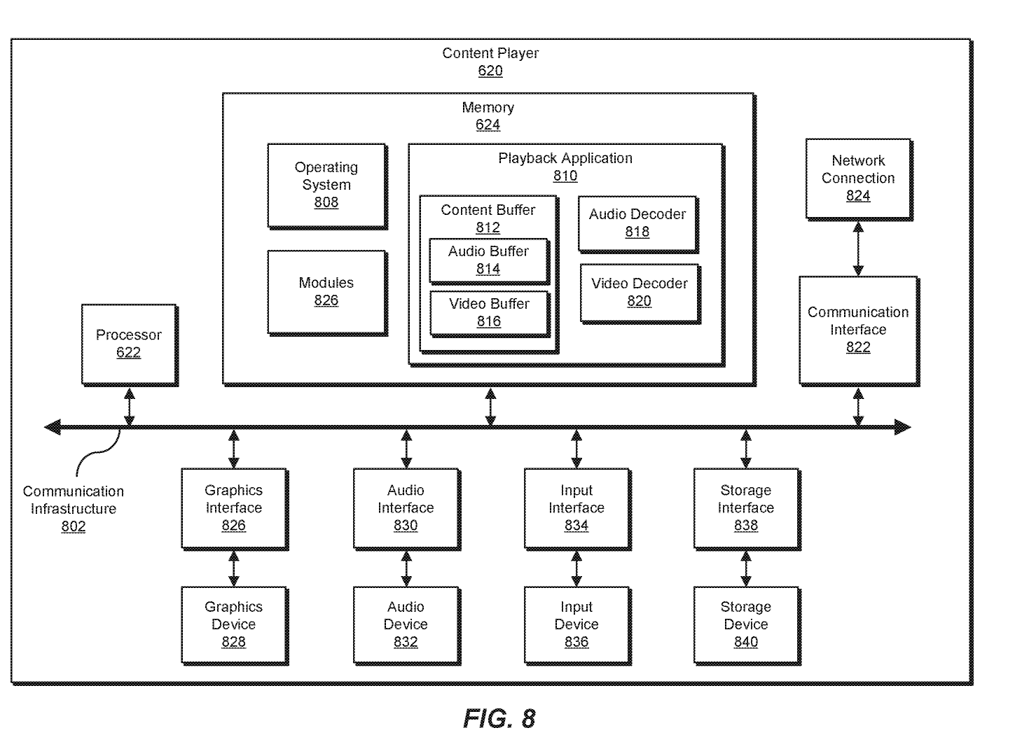

FIG. 8 is a block diagram of an exemplary implementation of content player 620 of FIG. 6. Content player 620 generally represents any type or form of computing device capable of reading computer-executable instructions. Content player 620 may include, without limitation, laptops, tablets, desktops, servers, cellular phones, multimedia players, embedded systems, wearable devices (e.g., smart watches, smart glasses, etc.), smart vehicles, gaming consoles, internet-of-things (IoT) devices such as smart appliances, variations or combinations of one or more of the same, and/or any other suitable computing device.

As shown in FIG. 8, in addition to processor 622 and memory 624, content player 620 may include a communication infrastructure 802 and a communication interface 822 coupled to a network connection 824. Content player 620 may also include a graphics interface 826 coupled to a graphics device 828, an audio interface 830 coupled to an audio device 832, an input interface 834 coupled to an input device 836, and a storage interface 838 coupled to a storage device 840.

Communication infrastructure 802 generally represents any type or form of infrastructure capable of facilitating communication between one or more components of a computing device. Examples of communication infrastructure 802 include, without limitation, any type or form of communication bus (e.g., a peripheral component interconnect (PCI) bus, PCI Express (PCIe) bus, a memory bus, a frontside bus, an integrated drive electronics (IDE) bus, a control or register bus, a host bus, etc.).

As noted, memory 624 generally represents any type or form of volatile or non-volatile storage device or medium capable of storing data and/or other computer-readable instructions. In some examples, memory 624 may store and/or load an operating system 808 for execution by processor 622. In one example, operating system 808 may include and/or represent software that manages computer hardware and software resources and/or provides common services to computer programs and/or applications on content player 620.

Operating system 808 may perform various system management functions, such as managing hardware components (e.g., graphics interface 826, audio interface 830, input interface 834, and/or storage interface 838). Operating system 808 may also process memory management models for playback application 810. The modules of playback application 810 may include, for example, a content buffer 812, an audio decoder 818, and a video decoder 820.

Playback application 810 may be configured to retrieve digital content via communication interface 822 and play the digital content through graphics interface 826. A video decoder 820 may read units of video data from audio buffer 814 and/or video buffer 816 and may output the units of video data in a sequence of video frames corresponding in duration to the fixed span of playback time. Reading a unit of video data from video buffer 816 may effectively de-queue the unit of video data from video buffer 816. The sequence of video frames may then be rendered by graphics interface 826 and transmitted to graphics device 828 to be displayed to a user.

In situations where the bandwidth of distribution infrastructure 610 is limited and/or variable, playback application 810 may download and buffer consecutive portions of video data and/or audio data from video encodings with different bit rates based on a variety of factors (e.g., scene complexity, audio complexity, network bandwidth, device capabilities, etc.). In some embodiments, video playback quality may be prioritized over audio playback quality. Audio playback and video playback quality may also be balanced with each other, and in some embodiments audio playback quality may be prioritized over video playback quality.

Content player 620 may also include a storage device 840 coupled to communication infrastructure 802 via a storage interface 838. Storage device 840 generally represent any type or form of storage device or medium capable of storing data and/or other computer-readable instructions. For example, storage device 840 may be a magnetic disk drive, a solid-state drive, an optical disk drive, a flash drive, or the like. Storage interface 838 generally represents any type or form of interface or device for transferring data between storage device 840 and other components of content player 620.

Many other devices or subsystems may be included in or connected to content player 620. Conversely, one or more of the components and devices illustrated in FIG. 8 need not be present to practice the embodiments described and/or illustrated herein. The devices and subsystems referenced above may also be interconnected in different ways from that shown in FIG. 8. Content player 620 may also employ any number of software, firmware, and/or hardware configurations.

### Example Embodiments

Example 1: A computer-implemented method includes (1) initiating, by a computing device, an instance of a game running on a game engine, (2) detecting, by the computing device using a software development kit (SDK), a list of input devices connected to the instance of the game, (3) receiving, by the SDK, an input event from an event handler of an input device in the list of input devices, (4) masking, by the computing device, the input event using an Application Programming Interface (API) for the game engine to generate an altered input event, and (5) injecting, by the API, the altered input event to the instance of the game from the SDK.

Example 2: The method of Example 1, where detecting the list of input devices includes exposing event handlers on each input device in the list of input devices and creating an input device instance for at least one device in the list of input devices.

Example 3: The method of any of Examples 1-2, where receiving the input event includes receiving the input event from the input device instance of the input device and identifying the input device.

Example 4: The method of any of Examples 1-3, where masking the input event includes formatting the input event based on a setting of the game instance, formatting the input event based on a format of an operating system, and/or adding metadata about the input event.

Example 5: The method of any of Examples 1-4, further including initiating an SDK input mode in response to initiating the instance of the game.

Example 6: The method of any of Examples 1-5, further including (1) receiving, by the API, a request to use a game engine input mode and (2) switching from the SDK input mode to the game engine input mode.

Example 7: The method of any of Examples 1-6, where the game engine input mode includes a mode to inject the input event through an interface between the game engine and an operating system.

Example 8: The method of any of Examples 1-7, where the SDK input mode includes a mode to inject the input event through the API as the event handler of the input device to bypass the operating system.

Example 9: The method of any of Examples 1-8, further including receiving, during the SDK input mode, a different input event through a game engine input mode such that the SDK input mode and the game engine input mode are both enabled.

Example 10: A system that includes at least one physical processor and physical memory including computer-executable instructions that, when executed by the physical processor, cause the physical processor to (1) initiate an instance of a game running on a game engine, (2) detect, using a software development kit (SDK), a list of input devices connected to the instance of the game, (3) receive, by the SDK, an input event from an event handler of an input device in the list of input devices, (4) mask the input event using an Application Programming Interface (API) for the game engine to generate an altered input event, and (5) inject, by the API, the altered input event to the instance of the game from the SDK.

Example 11: The system of Example 10, where detecting the list of input devices includes exposing event handlers on each input device in the list of input devices and creating an input device instance for at least one device in the list of input devices.

Example 12: The system of any of Examples 10-11, where receiving the input event includes receiving the input event from the input device instance of the input device and identifying the input device.

Example 13: The system of any of Examples 10-12, where masking the input event includes formatting the input event based on a setting of the game instance, formatting the input event based on a format of an operating system, and/or adding metadata about the input event.

Example 14: The system of any of Examples 10-13, where the computer-executable instructions, when executed by the physical processor, further cause the physical processor to initiate an SDK input mode in response to initiating the instance of the game.

Example 15: The system of any of Examples 10-14, where the computer-executable instructions, when executed by the physical processor, further cause the physical processor to (1) receive, by the API, a request to use a game engine input mode and (2) switch from the SDK input mode to the game engine input mode.

Example 16: The system of any of Examples 10-15, where the game engine input mode includes a mode to inject the input event through an interface between the game engine and an operating system.

Example 17: The system of any of Examples 10-16, where the SDK input mode includes a mode to inject the input event through the API as the event handler of the input device to bypass the operating system.

Example 18: The system of any of Examples 10-17, where the computer-executable instructions, when executed by the physical processor, further cause the physical processor to receive, during the SDK input mode, a different input event through a game engine input mode such that the SDK input mode and the game engine input mode are both enabled.

Example 19: A non-transitory computer-readable medium including one or more computer-executable instructions that, when executed by at least one processor of a computing device, cause the computing device to (1) initiate an instance of a game running on a game engine, (2) detect, using a software development kit (SDK), a list of input devices connected to the instance of the game, (3) receive, by the SDK, an input event from an event handler of an input device in the list of input devices, (4) mask the input event using an Application Programming Interface (API) for the game engine to generate an altered input event, and (5) inject, by the API, the altered input event to the instance of the game from the SDK.

Example 20: The non-transitory computer-readable medium of Example 19, where the computer-executable instructions, when executed by the processor, further cause the computing device to initiate an SDK input mode in response to initiating the instance of the game.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive an input event from a handler of an input device, transform the input event using an API to format the input, output a result of the transformation to a game instance, use the result of the transformation to inject the input event into game logic, and store the result of the transformation to execute a command for the game instance. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
initiating, by a computing device, an instance of a game running on a game engine;
detecting, by the computing device using a software development kit (SDK), a list of input devices connected to the instance of the game;
receiving, by the SDK, an input event from an event handler of an input device in the list of input devices;
masking, by the computing device, the input event using an Application Programming Interface (API) for the game engine to generate an altered input event; and
injecting, by the API, the altered input event to the instance of the game from the SDK.

2. The method of claim 1, wherein detecting the list of input devices comprises:
exposing event handlers on each input device in the list of input devices; and
creating an input device instance for at least one device in the list of input devices.

3. The method of claim 2, wherein receiving the input event comprises:
receiving the input event from the input device instance of the input device; and
identifying the input device.

4. The method of claim 1, wherein masking the input event comprises at least one of:
formatting the input event based on a setting of the game instance;
formatting the input event based on a format of an operating system; or
adding metadata about the input event.

5. The method of claim 1, further comprising initiating an SDK input mode in response to initiating the instance of the game.

6. The method of claim 5, further comprising:
receiving, by the API, a request to use a game engine input mode; and
switching from the SDK input mode to the game engine input mode.

7. The method of claim 6, wherein the game engine input mode comprises a mode to inject the input event through an interface between the game engine and an operating system.

8. The method of claim 7, wherein the SDK input mode comprises a mode to inject the input event through the API as the event handler of the input device to bypass the operating system.

9. The method of claim 5, further comprising receiving, during the SDK input mode, a different input event through a game engine input mode such that the SDK input mode and the game engine input mode are both enabled.

10. A system comprising:
at least one physical processor; and
physical memory comprising computer-executable instructions that, when executed by the physical processor, cause the physical processor to:
initiate an instance of a game running on a game engine;
detect, using a software development kit (SDK), a list of input devices connected to the instance of the game;
receive, by the SDK, an input event from an event handler of an input device in the list of input devices;
mask the input event using an Application Programming Interface (API) for the game engine to generate an altered input event; and
inject, by the API, the altered input event to the instance of the game from the SDK.

11. The system of claim 10, wherein detecting the list of input devices comprises:
exposing event handlers on each input device in the list of input devices; and
creating an input device instance for at least one device in the list of input devices.

12. The system of claim 11, wherein receiving the input event comprises:
receiving the input event from the input device instance of the input device; and
identifying the input device.

13. The system of claim 10, wherein masking the input event comprises at least one of:
formatting the input event based on a setting of the game instance;
formatting the input event based on a format of an operating system; or
adding metadata about the input event.

14. The system of claim 10, wherein the computer-executable instructions, when executed by the physical processor, further cause the physical processor to initiate an SDK input mode in response to initiating the instance of the game.

15. The system of claim 14, wherein the computer-executable instructions, when executed by the physical processor, further cause the physical processor to:
receive, by the API, a request to use a game engine input mode; and
switch from the SDK input mode to the game engine input mode.

16. The system of claim 15, wherein the game engine input mode comprises a mode to inject the input event through an interface between the game engine and an operating system.

17. The system of claim 16, wherein the SDK input mode comprises a mode to inject the input event through the API as the event handler of the input device to bypass the operating system.

18. The system of claim 14, wherein the computer-executable instructions, when executed by the physical processor, further cause the physical processor to receive, during the SDK input mode, a different input event through a game engine input mode such that the SDK input mode and the game engine input mode are both enabled.

19. A non-transitory computer-readable medium comprising one or more computer-executable instructions that, when executed by at least one processor of a computing device, cause the computing device to:
initiate an instance of a game running on a game engine;
detect, using a software development kit (SDK), a list of input devices connected to the instance of the game;
receive, by the SDK, an input event from an event handler of an input device in the list of input devices;
mask the input event using an Application Programming Interface (API) for the game engine to generate an altered input event; and
inject, by the API, the altered input event to the instance of the game from the SDK.

20. The non-transitory computer-readable medium of claim 19, wherein the computer-executable instructions, when executed by the processor, further cause the computing device to initiate an SDK input mode in response to initiating the instance of the game.
